(19) United States
(12) Patent Application Publication
(10) Pub. No.: US 2026/0073059 A1
(43) Pub. Date: Mar. 12, 2026

(54) Secure Storage System and Method of Use

(71) Applicant: KINGSTON DIGITAL, INC., Fountain Valley, CA (US)

(72) Inventors: Marvin YUEN, Fountain Valley, CA (US); Jason CHEN, Fountain Valley, CA (US); Choon Tak TANG, Fountain Valley, CA (US)

(21) Appl. No.: 18/793,377

(22) Filed: Aug. 2, 2024

(51) Int. Cl. G06F 21/60; G06F 21/62; G06F 21/78

(52) U.S. Cl. CPC G06F 21/602; G06F 21/6218; G06F 21/78

(57) ABSTRACT

A secure data storage system is disclosed. The secure data storage system includes a processing module, a database, and an input module. The processing module includes an authentication module, an encryptor, and a memory controller, and is coupled to the database and input module. The database includes at least one public partition, at least one system partition, and one or more private partitions. The data on the one or more private partitions is encrypted and unlocked by a corresponding user key. The secure data storage system performs functions including: receiving a user key from a user input device for processing by the processing module; and validating the user key by the processing module.

### FIELD OF THE INVENTION

The present invention relates generally to data storage and more specifically to providing one or more private partitions with a public partition that is accessible in a locked state of a drive.

### BACKGROUND OF THE INVENTION

In data storage, how data is properly partitioned, stored, encrypted and decrypted, authorized, retrieved and recovered, while allowing the sharing of data, e.g. software programs for communicating with the host system or a server, user manual, warranty document, product safety documents, general data in one or more private partitions with a public partition that is accessible in a locked state of a drive are big challenges to the IT industry.

It is important to be able to address the challenges mentioned above to provide an ultra-secure storage system with one or more private partitions with a public partition that is accessible in a locked state of a drive to allow the sharing of data.

Accordingly, what is needed is a system and method for overcoming the above-identified issues. The present invention addresses such a need.

### SUMMARY OF THE INVENTION

In accordance with an aspect of the present invention, a secure storage system is disclosed including a processing module, a database, and an input module, wherein the processing module includes an authentication module, an encryptor, and a memory controller, and is coupled to the database and input module, and wherein the database includes at least one public partition, at least one system partition, and one or more private partitions, the data on the one or more private partitions are encrypted and unlocked by a corresponding user key; wherein the secure storage system performs functions including: receiving a user key from a user input device for processing by the processing module; and validating the user key by the processing module.

In accordance with an aspect of the present invention, computer-implemented secure storage method is disclosed including receiving a user key from a user input device for processing by a processing module; and validating the user key by the processing module; wherein the processing module includes an authentication module, an encryptor, and a memory controller processing module, and is coupled to a database and an input module, and wherein the database includes at least one public partition, at least one system partition, and one or more private partitions, the data on the one or more private partitions are encrypted and unlocked by a corresponding user key. The at least one system partition may also be encrypted or obfuscated.

### BRIEF DESCRIPTION OF THE DRAWINGS

FIGS. 1A-1B are exemplary configurations of the block diagrams of a secure storage device.

FIG. 2 is a is a block diagram of the Processing Module.

FIGS. 3A-3B are exemplary configurations of the block diagrams of the database.

FIG. 4A-4B are block diagrams showing exemplary configurations of a secure storage system.

FIGS. 5A-5D are exemplary configurations of public and private partitions in secure storage system.

FIG. 6 is a flow chart for a user to initialize the secure storage device in accordance with the present invention.

FIG. 7 is a flow chart for a user to unlock the secure storage device in accordance with the present invention.

FIG. 8 is a flow chart for a user to change a user key for the secure storage device in accordance with the present invention.

FIG. 9 is a flow chart for initialization and private partition creating process in accordance with the present invention.

FIG. 10 is a flow chart for user key authentication and access gating process in accordance with the present invention.

FIG. 11 is a flow chart for a user key change with secure transfer process in accordance with the present invention.

### DETAILED DESCRIPTION

The present invention relates generally to data storage and more specifically to providing an ultra-secure storage system including a private partition and a public partition either in read/write mode or in read-only mode to allow the sharing of data. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

Current secure storage systems with an input module do not have public partitions for storing associated software programs and documents or for general usage. Having a public partition allows the critical software and documents to be loaded directly on the product itself, without any additional user intervention (e.g. downloading from internet, scanning a QR code . . . etc.). Preloading the software and documents on the secure storage system can prevent the malicious users from injecting virus/malwares/ransomware to the system. Additionally, having a public partition will obfuscate the presence of one or more private partitions.

Also, multiple users may be defined by adding multiple user keys and each key may be assigned different access privileges and/or partitions.

Further, current secure storage systems with an input module also requires the Authenticator to handle the user authentication while using the Encryptor to handle the data encryption and decryption. The present application improves on current secure storage systems by having the Encryptor encrypt the access key by using the user key which diversifies the risk of data breach and making the data more secure by adding an additional controller in the user authentication flow. The encryptor function may be performed by the same physical part that is the input module or processing module or both.

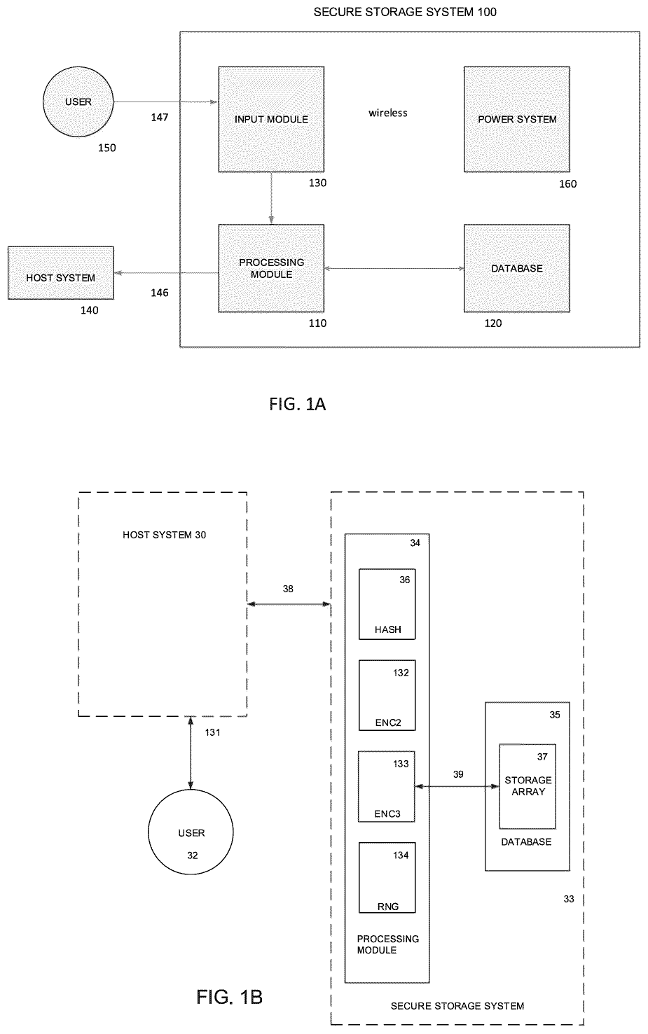

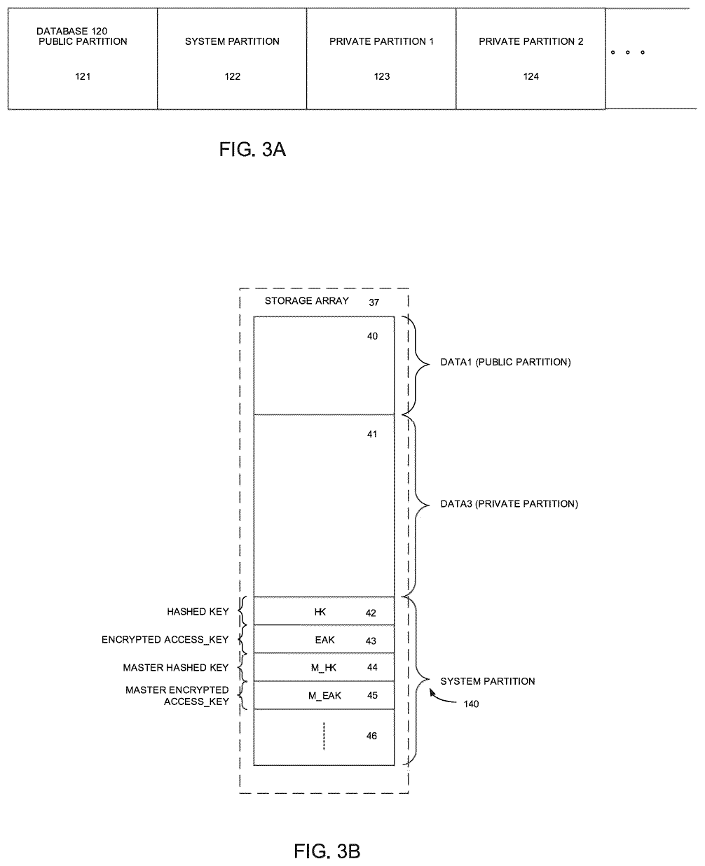

The USB storage systems depicted in FIGS. 1 and 3 provide a public partition (either in read/write mode or in read-only mode) to allow the sharing of data, e.g. software programs for communicating with the host system or a server, user manual, warranty document, product safety documents, general data . . .etc. The USB storage method and system in accordance with the present invention has significant advantages over the prior art including:
1. One or more private partitions which is unknown to a 3rd party
2. One or more private partitions can be configured with one or more user keys
3. Self-destructing one or more of the partitions after one or more incorrectly entered user keys.
4. Control read/write access for one or more partitions based on one or more user keys entered.
5. Option to mount only 1 partition at a time (either public or private partition): Some operating systems (e.g. some Linux distributions...etc.) do not support device with multiple partitions.
6. One or more partitions can have read/write permissions configured

The method and system in accordance with the present invention is applicable in many areas including but not limited to a USB storage system, Flash storage system, disk storage system, portable storage device, corporate storage system, personal computer server, wireless communication and multimedia system. To describe the features of the present invention in more detail, refer now to the following description in conjunction with the drawings.

FIG. 1A is a block diagram of a secure storage system 100, in accordance with one embodiment of the present invention. The secure storage system 100 comprises a processing module 110 coupled to the Input module 130. The Processing Module 110 is further coupled to database 120. A power system 160 may be included inside the secure storage system 100 for supplying power to the system if the secure storage system 100 is not connecting to Host System 140 (or if the system is not getting power from the Host System 140).

FIG. 1B is a block diagram of the secure storage system 33 in accordance with one embodiment of the present invention. The host system 30, comprises a processor (not shown), memory (not shown), a storage interface 38 and a user interface 131. It works with the user 32 through a user interface 131 and works with the secure storage system 33 through a storage interface 38. Previously, a utility and driver was needed to serve as a mediator between the storage interface 38 and the user interface 131 which was a software utility residing on the host system or a browser link to the secure storage data system 33. In the present application, a special utility and driver is not needed. All previous features of the utility and driver can be performed on the storage device itself which for physical implementations of this process, in alternative embodiments, public/private partitions may be assigned to physical NAND dies and/or chips, where in hiding a partition will deactivate a die and/or chip. In another alternative embodiment, the authenticator may be a user interface device that is controlled by a memory controller (which may also serve as part of the authenticator and/or the encryptor). Therefore there is no need for specialty software or drivers. The browser link is preferable, as it is more universal and requires less system resources to work on cross platform devices. The secure storage system 33 also includes a storage controller (not shown), memory (not shown), processing module 34, a storage interface 38, and a database 35. The database 35 comprises a storage array 37 and a storage array interface 39. The processing module 34 includes a random number generator RNG 134, a hash function HASH 36, a first general encryption engine ENC2 132, a second data encryption engine ENC3 133, a storage interface 38 and a storage array interface 39.

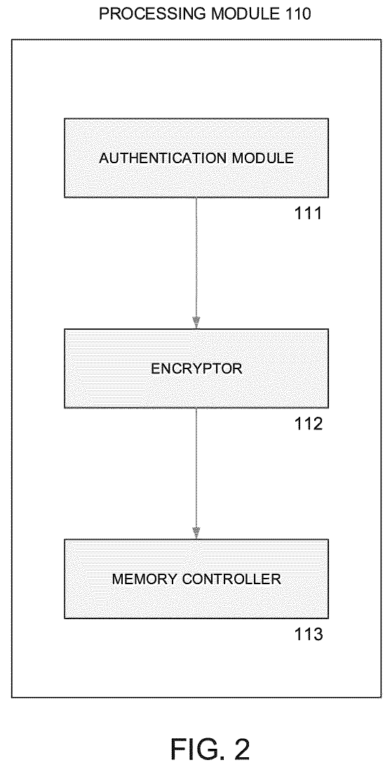

FIG. 2 is a block diagram of the Processing Module 110 comprising of an Authentication Module 111, an Encryptor 112 and a Memory controller 113.

FIG. 3A is a block diagram of the database 120 including a public partition 121, a system partition 122 and one or more private partitions 123, 124 and so on. The data on the private partitions are encrypted and only unlocked by a corresponding user key.

FIG. 3B is a block diagram of the storage array 37 including a public partition DATA1 40, a private partition DATA3 41 and a system partition 140. The public partition DATA1 40 is accessible to general public as the name implies. The data content is clear text and not encrypted. The private partition DATA3 41 is encrypted and is accessible through key authentication with correct access key. The system partition 140 is accessible only by secure storage system 33 internally. It is used to store a hashed key HK 42, an encrypted access key EAK 43, a master hashed key M_HK 44, a master encrypted access key M_EAK 45, and other data spaces 46.

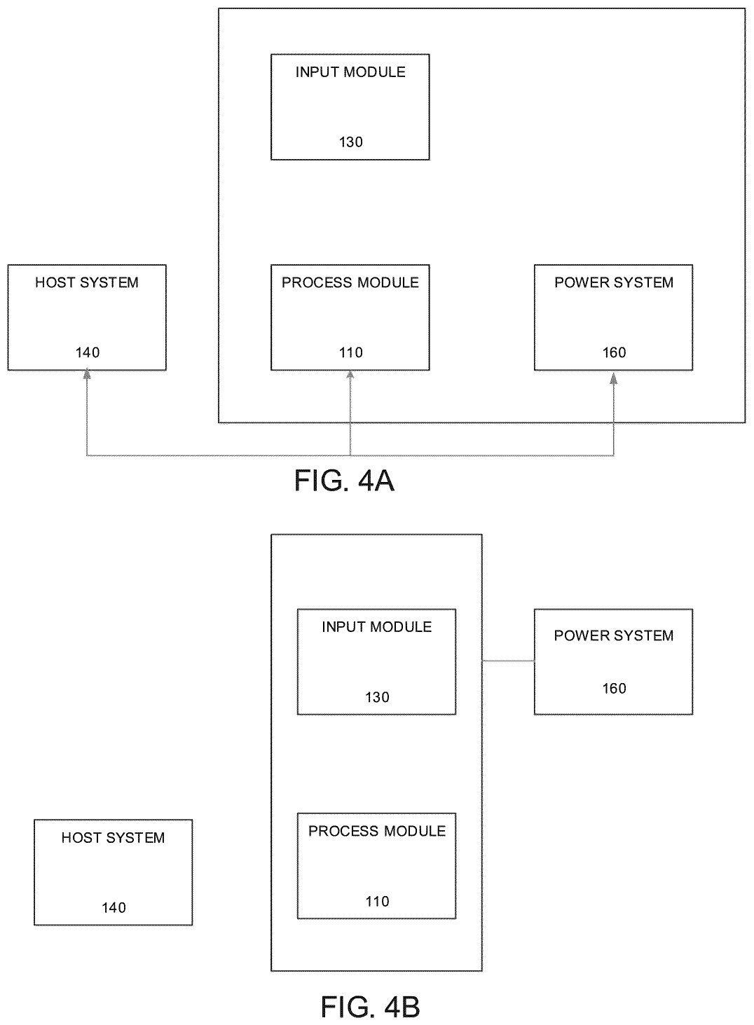

FIGS. 4A and 4B are block diagrams showing exemplary configurations of a secure storage system 100 with a power system 160. In one configuration, power system 160 is an internal subsystem in secure storage system 100. In another configuration, power system 160 is an external system that interfaces with secure storage system 100.

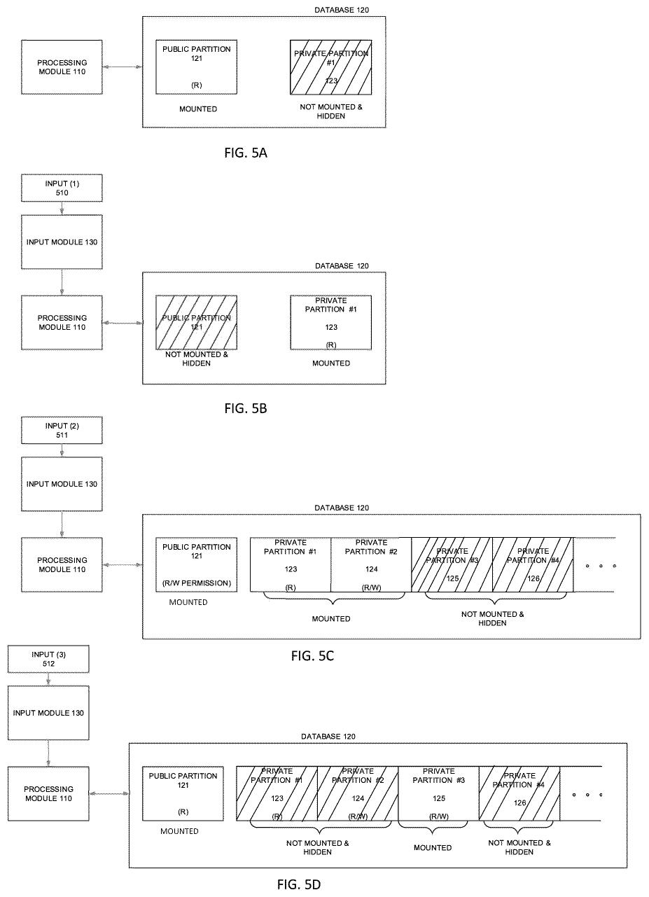

FIG. 5 are exemplary configurations of public and private partitions in secure storage system 100.

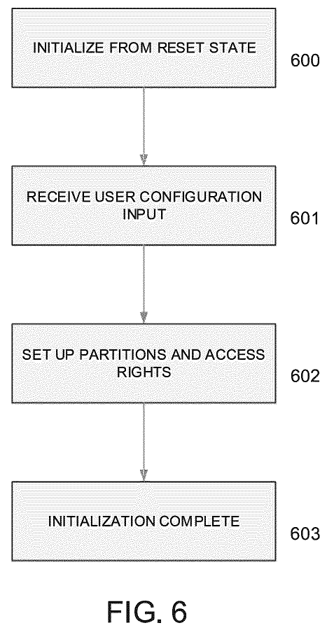

FIG. 6 is a method for a user to initialize the secure storage device 100.

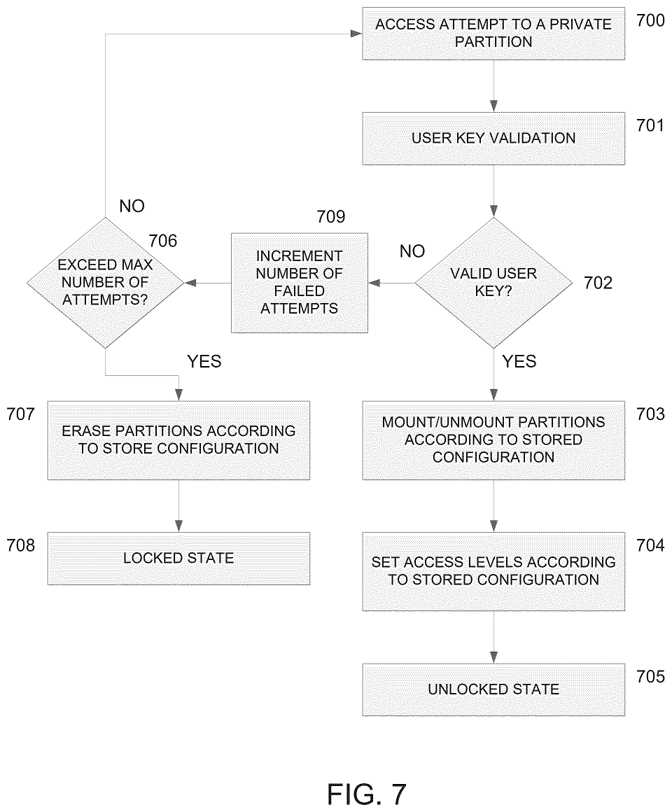

FIG. 7 is a method for a user to unlock the secure storage device 100.

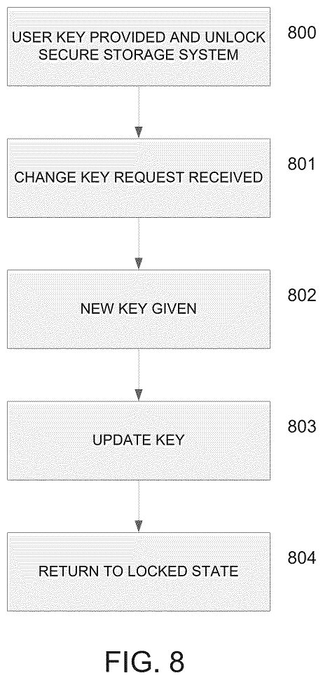

FIG. 8 is a method for a user to change a user key for the secure storage device 100.

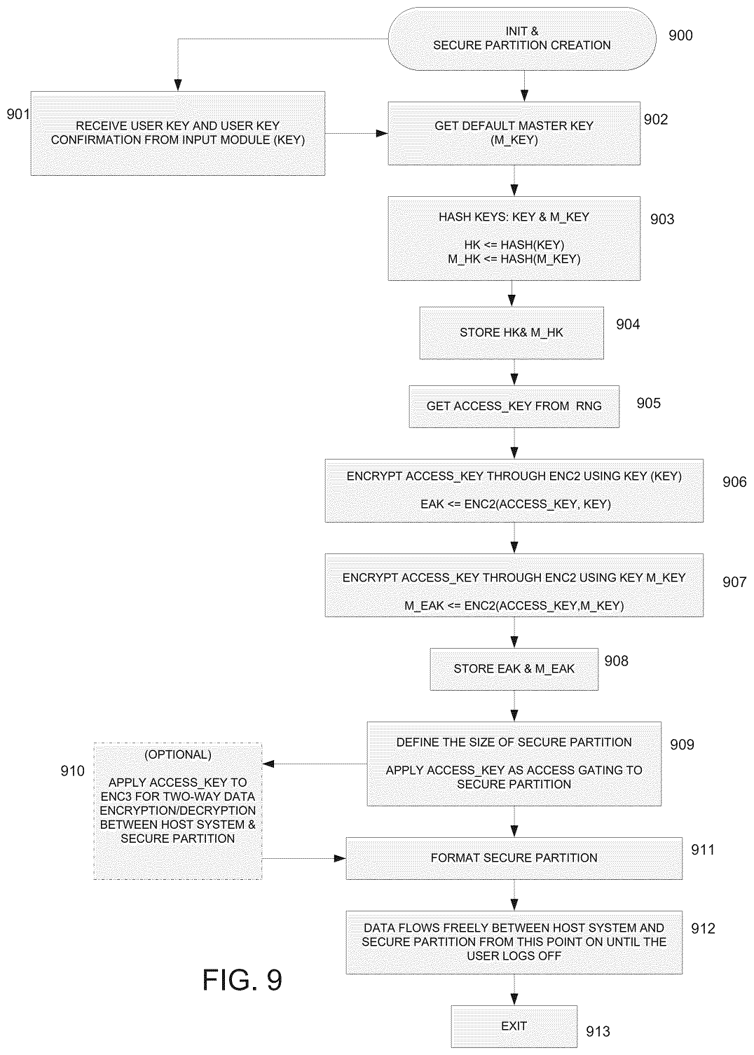

FIG. 9 is a method for initialization and private partition creating process.

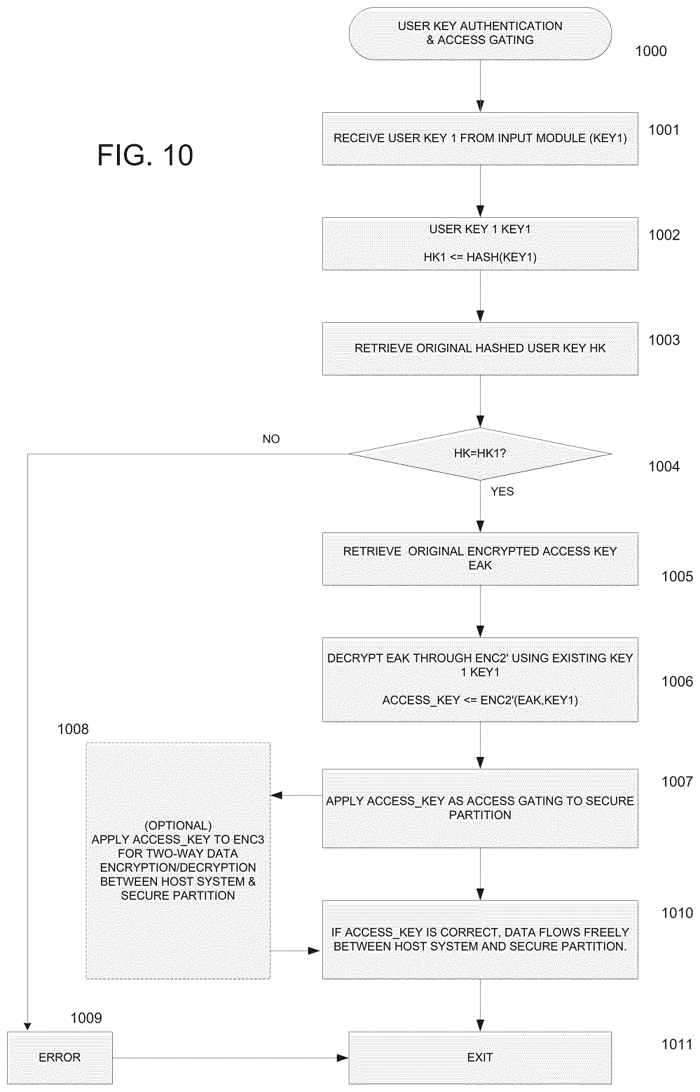

FIG. 10 is a method for user key authentication and access gating process.

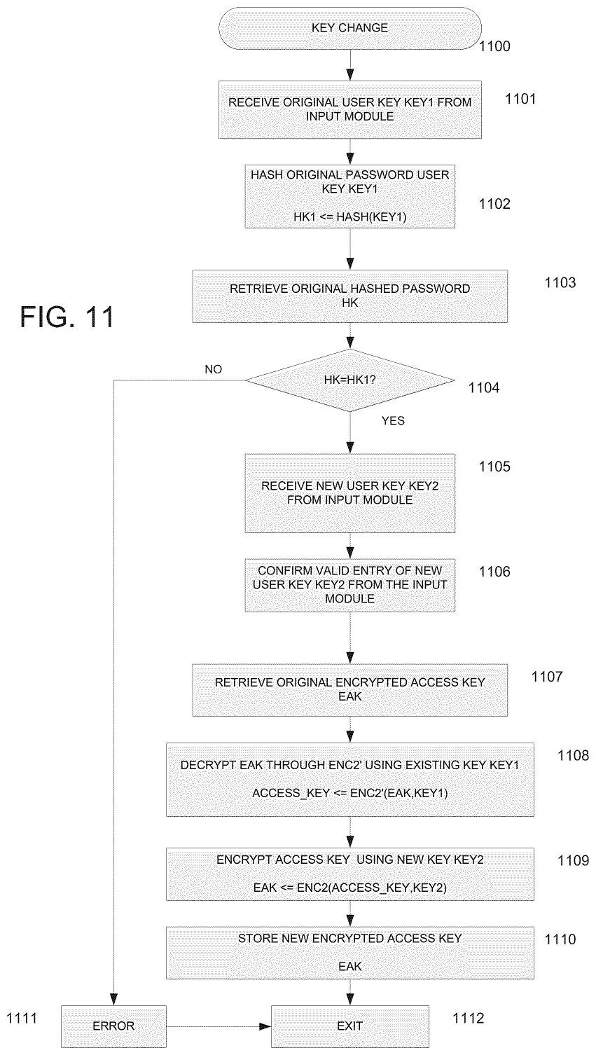

FIG. 11 is method for a user key change with secure transfer process.

Secure storage system 100 is a data storage system that protects data by having one or more private partitions that are unlockable by one or more user keys. A user key is provided to the secure storage system by a user input device and processed by a processing module 110. The processing module 110 validates the user key and unlocks predetermined private partitions with predetermined access privileges. The processing module 110 may also lock and/or change privileges to currently unlocked partitions.

In one of the embodiments, the processing module 110 comprises of an authentication module 111, an encryptor 112, and a memory controller 113. A user key is inputted by a user into the input module 130 and the inputted user key is passed to and authenticated by the authentication module 111. The authentication module 111 encodes the user key using a secure encryption algorithm such as Advanced Encryption Standard (AES) and passes the result-an encrypted user key, to an encryptor 112 for validation. If the encrypted user key passes validation by the encryptor 112, the encryptor 112 will pass the result to a memory controller 113 which will mount one or more private partitions with predetermined access privileges Additionally, one or more public and/or private partitions may be unmounted and/or have their access privileges changed.

In one of the embodiments, one or more partitions in the database 120 can be configured to have the read and/or write access be uniquely set per user key. Certain user keys may only access specific partitions and/or may only be able to write to those partitions or a subset thereof.

In one of the embodiments, the Processing Module 110 does not receive any input from the Input Module 130, it can respond by mounting the public partition 121 in the database 120 within the operating system of the host System).

In one of the embodiments, the Input Module 130 receives an identification query including a user key from the user 150. If authorized, the Processing Module 110 can respond by using the user key to decrypt the access key and then use the access key to decrypt the data on the Private partition 123 in the database 120 and allow the partition to be mounted within the operating system of the Host System 140. If not authorized, the Processing Module 110 may refuse to respond or reject the Host System 140's attempt to mount the storage device.

In one of the embodiments, the Input Module 130 receives an identification query from the user 150. If the user key is authenticated, the Processing Module 110 can respond by using the user key to decrypt the access key and then use the access key to decrypt the entire drive while relevant partitions are hidden or unhidden in the database 120.

In one of the embodiments, the Input Module 130 receives an identification query from the user 150. If the user key is authenticated, the Processing Module 110 can respond by using the user key to decrypt the access key and then use the access key to decrypt and unhide only relevant partitions in the database 120.

The Input Module 130 controls the input and receives the user key. The user key may comprise of numbers, letters, symbols, or special characters. In other embodiments, the user key comprises a retinal scan, voice identifier, wireless signal.

FIG. 4A shows that the Power System 160 can be included within the Secure Storage System 100 as an internal component. FIG. 4B shows that the Power System 160 can be an external component which is outside of the Secure Storage system 100. In the embodiment of FIG. 4A where the Power System 160 is included within the Secure Storage System 100, the power system can be charged by the Host system 140 when the Secure Storage System 100 is connected to the Host System 140.

FIGS. 5A-5D depicts four embodiments of the use cases. In the present invention, “read-only mode” (R) means the data in a partition cannot be overwritten. “read-write mode” (R/W) means data can be written to a partition or read from a partition.

In the embodiment as depicted in FIG. 5A, the Processing Module 110 does not receive any input from the Input Module 130. In this case, the Processing Module 110 mounts only the Public Partition 121 in read-only mode (R) while the Private Partition #1 123 is not mounted and hidden.

In embodiment as depicted in FIG. 5B, the Processing Module 110 receives Input (1) 510 from the Input Module 130. In this case, the Processing Module 110 mounts Private Partition #1 123 in read-only mode (R) while the Public Partition 121 is not mounted and hidden.

In embodiment as depicted in FIG. 5C, the Processing Module 110 receives Input (2) 511 from the Input Module 130. In this case, the Processing Module 110 mounts the Public Partition 121 (mounted) in read-write mode (R/W), the Private Partition #1 123 (mounted) in read-only mode (R), Private Partition #2 124 (mounted) in read-write mode (R/W) while the Private Partition #3 125 and Private Partition #4 126 are not mounted and hidden.

In embodiment as depicted in FIG. 5D, the Processing Module 110 receives Input (3) 512 from the Input Module 130. In this case, the Processing Module 110 mounts the Public Partition 121 (mounted) in read-only mode (R) and the Private Partition #3 125 (mounted) in read-write mode (R/W), while the other Private Partitions #1 123, #2, 124, and #4 126 are not mounted and hidden.

FIG. 6 shows an initialization flow for setting up the secure storage system 100 in an out of box or reset state. The secure storage system 100 is initially in a reset or out of box state in initialization step 600. A user configuration step 601 receives a configuration from the user containing information such as, but not limited to, number of partitions, user keys, sizes of partitions, and/or partition access privileges. A user may send the secure storage system 100 a configuration via any means of data transfer such as, but not limited to, a key press sequence, a file transfer to the public partition, a wireless upload. In a set up partitions and access rights step 602, the configuration is read by the secure storage system 100 and one or more private partitions are created, one or more partitions are associated to a specific user key, and the access rights to new and/or existing partitions may be set based on the specific user key. The secure storage system 100 finishes initialization and returns to an idle or locked state in initialization complete step 603.

FIG. 7 shows an unlocking flow for unlocking one or more private partitions of the secure storage system 100. The secure storage system 100 is in a locked state and receives an access attempt to a private partition 700 with a user key being inputted. The user key validation step 701 confirms the user key is a valid user key. User key validation step 701 may also perform additional processing commands such as, but not limited to, hashing, encrypting, and/or translating the provided user key. At user key check 702, if the user key is valid, a mount/unmount partition step 703 is performed where the partitions associated with the user key are mounted and the unassociated partitions are unmounted based on a previously provided user configuration. Set access levels step 704 further sets the read and/or write permissions of the mounted partitions based on the previously provided user configuration. The secure storage system 100 then enters an unlocked state 705 where it awaits data transfer commands from the host system.

If the user key validation step 701 determines the user key is not valid, the secure storage system 100 performs an increment number-of-attempts counter step 709 and then a check number of attempts (NOA) 706 is performed. If the number of NOA exceeds a predefined user threshold of attempts, an erase partitions step 707 performed and may erase one or more partitions according a previously provided user configuration. The secure storage system 100 then enters a locked state 708 where it may receive additional user keys or require a system reset. If the number of invalid user keys entered does not exceed the maximum NOA, the secure storage system 100 returns to a locked state until another access is attempted.

FIG. 8 shows a user key change flow for changing a user key stored in the secure storage system 100. A valid user key is provided in unlock step 800. A change key request 801 is received by the system and the user provides a new key 802. The key is updated 803 in the stored configuration of secure storage system 100 and the system returns to a locked state 804.

During the initialization and private partition creating process 900, as shown in FIG. 9, the new user key KEY is requested from the Input Module 130 and confirmed, via step 901. The default master key M_KEY is retrieved, via step 902. Both master key and user key are hashed through the HASH function, via step 903. The resulting hashed keys HK and M_HK are stored, via step 904. Afterwards, an access key ACCESS KEY is generated by the random number generator RNG, via step 905. The access key ACCESS KEY is encrypted through encryption engine ENC2 using user key KEY as a key and stored as EAK, via steps 906, 908. The access key is also encrypted through encryption engine ENC2 using master key M_KEY as a key and stored as M_EAK, via steps 907, 908. The size of the private partition is then defined by the user. The access key ACCESS KEY is further used as an access gating to private partition, via step 909. The raw data is optionally encrypted/decrypted, via step 910, using ACCESS KEY as a key through an encryption/decryption engine ENC3 between host system 30 and at least one of private partitions 123-126. At least one of the private partitions 123-126 is formatted and prepared for use later, via step 911. Data flows freely between host system 140 and at least one of private partitions 123-126 from this point on until the user logs off via step 912. The secure storage system can be re-initialized anytime by the user.

During the user key authentication and access gating process 1000, as shown in FIG. 10, the user key 1 KEY1 is requested from the Input Module 130, via step 1001. The user key 1 KEY1 is then hashed as HK1 through HASH function, via step 1002. The original hashed user key HK is retrieved from storage, via step 1003. HK and HK1 are compared to see if they match. If there is no match, it means the user key 1 KEY1 entered is incorrect and an error is reported, via step 1009. If the result matches, then the original encrypted access key EAK is retrieved, via step 1005. EAK is then decrypted through encryption/decryption engine ENC2 using user key 1 KEY1 as a key to retrieve access key ACCESS KEY, via step 1006. Here ENC2′ is used to denote decryption as opposed to ENC2 as encryption. ACCESS KEY is applied as access gating to secure storage. The raw data is optionally encrypted/decrypted, via step 1008, using ACCESS KEY as a key through an encryption/decryption engine ENC3 between host system 30 and at least one of private partitions 123-126. If access key ACCESS KEY is correct, data is permitted to flow freely between host system 140 and private partition 123, via step 1010. The access key for access gating serves as a second-level user key authentication. The user key authentication and access gating process is exited at 1011 when one of the three following conditions are met: 1. User logs off, 2. Error due to User Key being incorrect, and 3. Power off, e.g. device is removed from the host system, etc.

The present invention has several advantages over conventional approaches:
a. The original user key is not stored in actual storage. Only the one way hashed value of the user key is stored. It is therefore more secure.
b. Even if the hashed user key is sniffed or the comparison mechanism is compromised by an insider or by a collision, the access key can only be decrypted by the correct user key presented by the user. Again, the correct user key is never stored and cannot be compromised which adds an extra degree of magnitude to the data security. Once the access gating is opened through the correct access key, the data storage transfer channel is established which adds another layer of data security to avoid hacking to the data storage in its raw data format. It utilizes another encryption/decryption engine ENC3, via steps 910, 1008 to process the data between the host system 30 and the secure storage system such that data can flow freely, until the user logs off. The encrypted data, if retrieved in its raw data format, can with stand brute force attack for trial-and-error decryption without proper access key. The user key authentication and access gating utility 1000 can apply to master user as well to provide a legitimate secure back door for access to data, if necessary.

During the user key change process 1100, as shown in FIG. 11, the original user key KEY1 is received, via step 1101, through input module 130. In step 1101, the user enters the new use key with or without a prompt from the device. The original user key KEY1 is hashed through hash function HASH as HK1, via step 1102. The original hashed user key HK is then retrieved from storage, via step 1103. HK and HK1 are compared to see if they match via step 1104. If HK and HK1 do not match, it means the user key KEY1 entered is incorrect and an error is reported, via step 1111. If the result matches, then a new user key KEY2 is received from the input module 130, via step 1105. The new user key KEY2 is further confirmed by the input module 130, via step 1106. The original encrypted access key EAK is retrieved, via step 1107. EAK is then decrypted through encryption/decryption engine ENC2 using user key KEY1 as a key to retrieve access key ACCESS_KEY, via step 1108. The access key ACCESS_KEY is then re-encrypted through /cryption/ decryption engine ENC2 using the new user key KEY2 as a key, via step 1109. The resulting encrypted access key EAK is then stored, via step 1110. The user key change process is exited at 1112 when one of the three following conditions are met: 1. Operation is completed, 2. Error due to User Key being incorrect, and 3. Power off, e.g. device is removed from the host system, etc.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

1. A secure storage system, comprising:
a processing module, a database, and an input module,
wherein the processing module includes an authentication module, an encryptor, and a memory controller, and is coupled to the database and input module, and
wherein the database includes at least one public partition, at least one system partition, and one or more private partitions, the data on the one or more private partitions are encrypted and unlocked by a corresponding user key;
wherein the secure storage system performs functions including:
receiving a user key from a user input device for processing by the processing module; and
validating the user key by the processing module.

2. The secure storage system of claim 1, wherein the validating the user key includes:
passing and authenticating the user key by the authentication module.

3. The secure storage system of claim 2, wherein the validating the user key further includes:
encoding the user key using an algorithm and passing the encoded user key to the encryptor for validation.

4. The secure storage system of claim 3, performing further functions including:
in response to the encoded user key passing validation, passing the encoded user key to the memory controller by the encryptor.

5. The secure storage system of claim 3, performing further functions including:
in response to the encoded user key not passing validation, performing a check number of attempts (NOA); and
in response to the number of the NOA exceeding a predefined threshold of attempts, erasing one or more partitions according to a previously provided user configuration.

6. The secure storage system of claim 3, performing further functions including:
entering a locked state while awaiting receiving additional user keys or requiring a system reset.

7. The secure storage system of claim 2, performing further functions including:
mounting, by the memory controller, the partitions associated with the user key.

8. The secure storage system of claim 2, performing further functions including:
setting read and/or write permissions of the mounted partitions based on a previously provided user configuration.

9. The secure storage system of claim 2, performing further functions including:
entering an unlocked state while awaiting data transfer commands from a host system.

10. The secure storage system of claim 2, performing further functions including:
unmounting, by the memory controller, the unassociated partitions based on a previously provided user configuration.

11. The secure storage system of claim 1, performing further functions including initialization of the secure storage system in an out of box or reset state, comprising:
receiving a user configuration input containing information including at least one of: a number of partitions, user keys, sizes of partitions, and partition access privileges;
reading the user configuration input and creating the one or more private and or public partitions, the one or more partitions associated to a specific user key, and access rights to new and/or existing partitions are set based on the specific user key; and
returning to an idle or locked state.

12. The secure storage system of claim 1, wherein in response to the user key being authenticated, performing further functions including one of:
decrypting the database and hiding or unhiding relevant partitions; or
decrypting and unhiding only relevant partitions.

13. A computer-implemented secure storage method, comprising:
receiving a user key from a user input device for processing by a processing module; and
validating the user key by the processing module;
wherein the processing module includes an authentication module, an encryptor, and a memory controller processing module, and is coupled to a database and an input module, and
wherein the database includes at least one public partition, at least one system partition, and one or more private partitions, the data on the one or more private partitions are encrypted and unlocked by a corresponding user key.

14. The computer-implemented secure storage method of claim 13, wherein the validating the user key includes:
passing and authenticating the user key by an authentication module.

15. The computer-implemented secure storage method of 14, wherein the validating the user key further includes:
encoding the user key using an algorithm and passing the encoded user key to the encryptor for validation.

16. The computer-implemented secure storage method of claim 15, further comprising:
in response to the encoded user key passing validation, passing the encoded user key to the memory controller by the encryptor.

17. The computer-implemented secure storage method of claim 15, further comprising:
in response to the encoded user key not passing validation, performing a check number of attempts (NOA); and
in response to the number of the NOA exceeding a predefined threshold of attempts, erasing one or more partitions according to a previously provided user configuration.

18. The computer-implemented secure storage method of claim 15, further comprising:
entering a locked state while awaiting receiving additional user keys or requiring a system reset.

19. The computer-implemented secure storage method of claim 14, further comprising:
mounting, by the memory controller, the partitions associated with the user key.

20. The computer-implemented secure storage method of claim 14, further comprising:
setting read and/or write permissions of the mounted partitions based on a previously provided user configuration.

21. The computer-implemented secure storage method of claim 14, further comprising:
entering an unlocked state while awaiting data transfer commands from a host system.

22. The computer-implemented secure storage method of claim 14, further comprising:
unmounting, by the memory controller, the unassociated partitions based on a previously provided user configuration.

23. The computer-implemented secure storage method of claim 13, further comprising:
initializing the secure storage system in an out of box or reset state, the initializing including:
receiving a user configuration input containing information including at least one of: a number of partitions, user keys, sizes of partitions, and partition access privileges;
reading the user configuration input and creating the one or more private and or public partitions, the one or more partitions associated to a specific user key, and access rights to new and/or existing partitions are set based on the specific user key; and
returning to an idle or locked state.

24. The computer-implemented secure storage method of claim 13, wherein in response to the user key being authenticated, the method further comprising one of:
decrypting the database and hiding or unhiding relevant partitions; or
decrypting and unhiding only relevant partitions.
